(19) United States
(12) Patent Application Publication
(10) Pub. No.: US 2016/0267872 A1
(43) Pub. Date: Sep. 15, 2016

(54) DISPLAY DEVICE

(71) Applicant: SAMSUNG DISPLAY CO., LTD., Yongin-Si (KR)

(72) Inventors: JUNHYUN PARK, Suwon-Si (KR); Sunghwan Kim, Yongin-Si (KR); Seyoung Song, Hwaseong-Si (KR); Kyoungju Shin, Hwaseong-Si (KR)

(21) Appl. No.: 15/017,907

(22) Filed: Feb. 8, 2016

(30) Foreign Application Priority Data
Mar. 11, 2015 (KR) 10-2015-0033983
Jul. 30, 2015 (KR) 10-2015-0108186

(51) Int. Cl. G09G 3/36

(52) U.S. Cl. CPC G09G 3/3688; G09G 3/3677; G09G 2300/0439; G09G 2300/0426; G09G 2310/08; G09G 2320/0223; G09G 2320/0204

(57) ABSTRACT

Provided is a display device. The display device includes a display panel comprising a plurality of pixels respectively connected to a plurality of gate lines and first and second data lines, a gate driving circuit configured to driving the plurality of gate lines, a data driving circuit configured to output a data output signal to a data output terminal in response to a data signal, and a driving controller configured to provide the data signal to the data driving circuit and control the gate driving circuit.

### CROSS-REFERENCE TO RELATED APPLICATIONS

This patent application claims priority to and the benefit of Korean Patent Application Nos. 10-2015-0033983, filed on Mar. 11, 2015, and 10-2015-0108186, filed on Jul. 30, 2015, the entire content of which is hereby incorporated by reference.

### DISCUSSION OF RELATED ART

An exemplary embodiment of the inventive concept herein relates to a display device.

In general, a display device includes a display panel for displaying an image, and a data driver and a gate driver for driving the display panel. The display panel includes a plurality of gate lines, a plurality of data lines, and a plurality of pixels. Each of the plurality of pixels includes a switching transistor, a liquid crystal capacitor, and a storage capacitor. The data driver outputs a data driving signal to the data lines and the gate driver outputs a gate driving signal to drive the gate lines.

After applying a gate on voltage to a predetermined gate line through a gate driver, the display device may display an image by providing a data voltage corresponding to an image signal to data lines through a data driver.

As the size of a display panel becomes larger, the number of data lines increases. Since the number of data lines that a data driver IC may drive is limited, larger display panels call for more data driver ICs.

### SUMMARY

According to an exemplary embodiment of the present invention, a display device includes a display panel, a gate driving circuit, a data driving circuit, a data output terminal, a first data line, a second data line and a driving controller. The display panel includes a plurality of pixels respectively connected to a plurality of gate lines and a plurality of data lines. The gate driving circuit drives the plurality of gate lines. The data driving circuit outputs a first data output signal to a first group of pixels and a second data output signal to a second group of pixels sequentially during one horizontal period. The data output terminal connected to the data driving circuit at a first end and connected to a first data line and a second data line at a second end. The first data line is connected to the first group of pixels. The second data line is connected to the second group of pixels. The driving controller provides a data signal to the data driving circuit and controls the gate driving circuit.

In an embodiment, the gate driving circuit may drive the plurality of gate lines sequentially to a gate on voltage. A first gate section where a first gate line is driven to the gate on voltage and a second gate section where a second gate line adjacent to the first gate line is driven to the gate on voltage at about a same time as the first gate line.

In an embodiment, the second gate section where the second gate line may be driven to the gate on voltage longer than the first gate section.

In an embodiment, the first gate section where the first gate line is driven to the gate on voltage may be one half of one horizontal period.

In an embodiment, the second gate section where the second gate line may be driven to the gate on voltage for more than one half of one horizontal period.

In an embodiment, a first data section where the data driving circuit outputs a first data output signal to a pixel of the first group of pixels connected to the first data line during a first half of one horizontal period.

In an embodiment, a second data section where the data driving circuit outputs a second data output signal to a pixel of the second group of pixels connected to the second data line during the second half of one horizontal period.

In an embodiment, the gate driving circuit may be disposed at one side of the display panel.

In an embodiment, the gate driving circuit may include a first gate driving circuit and a second gate driving circuit. The first gate driving circuit disposed at a first side surface of the display panel and configured to drive the first gate line. The second gate driving circuit disposed at a second side surface of the display panel and configured to drive the second gate line.

In an embodiment, the display panel may further include a third group of pixels connected to a third data line. The data output terminal of the data driving circuit may be connected to the first, second, and third data lines at the second end.

In an embodiment, the gate driving circuit may drive the plurality of gate lines sequentially to a gate on voltage. A first gate section where a first gate line is driven to the gate on voltage and a second gate section where a second gate line adjacent to the first gate line is driven to the gate on voltage at about a same time as the first gate line. A second gate section where the second gate line is driven to the gate on voltage and a third gate section where a third gate line adjacent to the second gate line is driven to the gate on voltage at about a same time as the second gate line.

In an embodiment, a first data section where the data driving circuit outputs a first data output signal to a pixel of a first group of pixels connected to the first data line during a first interval, wherein an interval is one third of one horizontal period.

In an embodiment, a second data section where the data driving circuit outputs a second data output signal to a pixel of a second group of pixels connected to the second data line during a second interval.

In an embodiment, a third data section where the data driving circuit outputs a third data output signal to a pixel of a third group of pixels connected to the third data line during a third interval.

According to an exemplary embodiment of the present invention, a display device includes a display panel, a driving controller, a gate driver circuit, one or more data driving circuits, and a data output terminal. The driving controller may provide a data output signal to one or more data driving circuits and control one or more gate driving circuits. The gate driving circuit may drive a plurality of gate lines. The one or more data driving circuits may output the data output signal to a data terminal. The data output terminal may output the data output signal to a plurality of data line, where each data line is connected to a plurality of pixels.

In an embodiment, a first data line and a second data line may be connected to the data output terminal. The first data line may be connected to a first group of pixels. The second data line may be connected to a second group of pixels. The gate driver circuit may be connected to a first group of gate lines and a second group of gate line. The first group of pixels may be driven by the first group of gate lines and the second group of pixels may be driven by the second group of gate lines.

In an embodiment, the gate driver circuit may output a first gate signal to the first group of gate lines and a second gate signal to the second group of gate lines. The first gate signal reaches a gate on voltage for a first half of one horizontal period. The second gate signal reaches a gate on voltage for one horizontal period and the first gate signal and the second gate signal may reach the gate on voltage at about the same time.

In an embodiment, the gate driving circuit includes a first gate driving circuit and a second gate driving circuit. The first gate driving circuit may be disposed at a first side surface of the display panel and may drive the first group of gate lines. The second gate driving circuit may be disposed at a second side surface of the display panel and may drive the second group of gate line.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a plan view of a display device according to an embodiment of the inventive concept.

FIG. 2 is a view illustrating a pixel arrangement of a display panel shown in FIG. 1.

FIG. 3 is a circuit diagram of a pixel according to an embodiment of the inventive concept.

FIG. 4 is a sectional view of a pixel according to an embodiment of the inventive concept.

FIG. 5 is a timing diagram illustrating an operation of the display device shown in FIG. 1.

FIG. 6 is a plan view of a display device according to another embodiment of the inventive concept.

FIG. 7 is a timing diagram illustrating an operation of the display device shown in FIG. 6.

FIG. 8 is a plan view of a display device according to another embodiment of the inventive concept.

FIG. 9 is a timing diagram illustrating an operation of the display device shown in FIG. 8.

### DETAILED DESCRIPTION

Hereinafter, embodiments of the inventive concept are described in more detail with reference to the accompanying drawings.

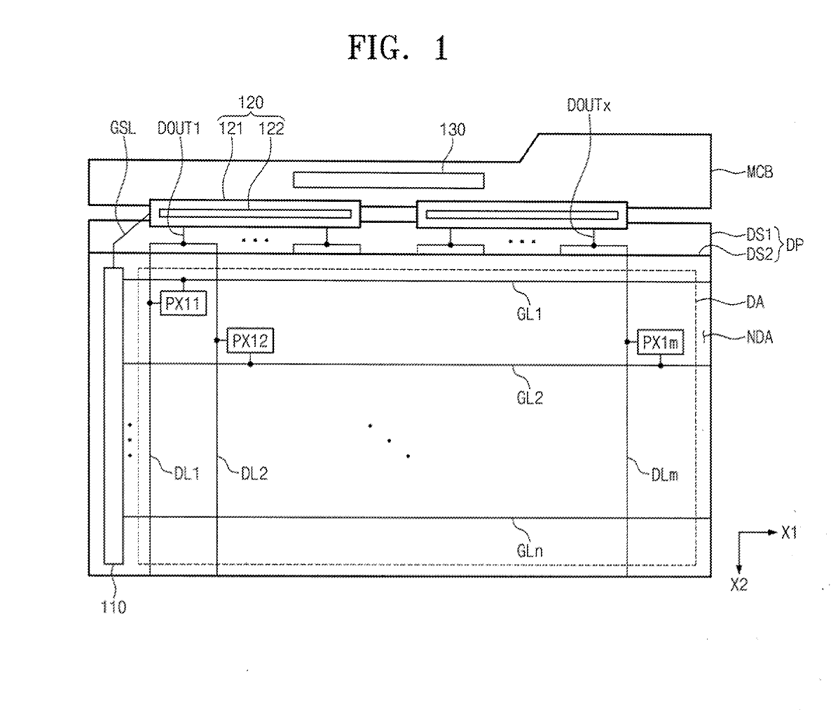

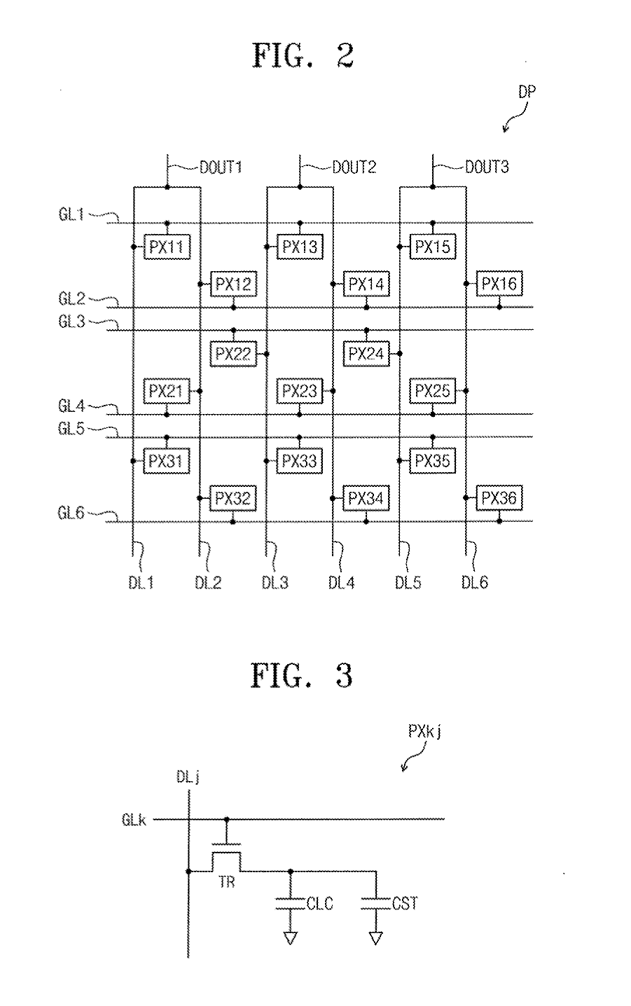

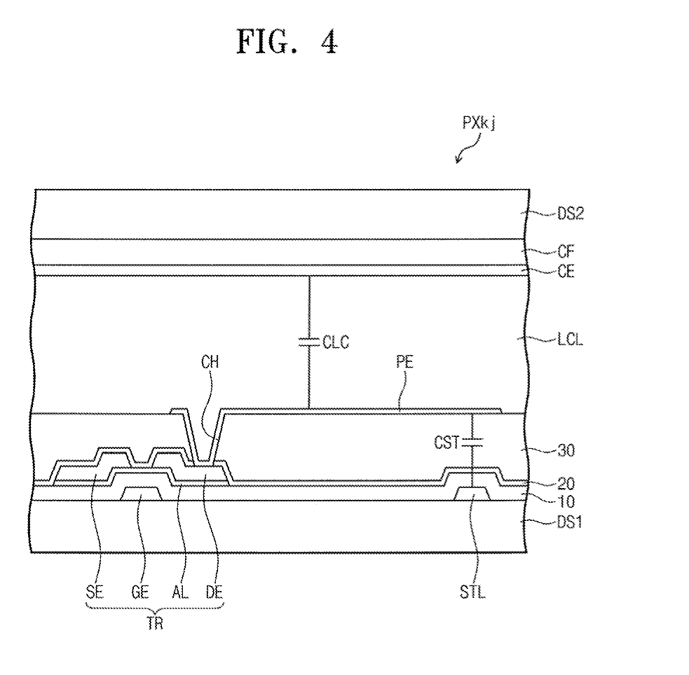

FIG. 1 is a plan view of a display device according to an embodiment of the inventive concept. FIG. 2 is a view illustrating a pixel arrangement of a display panel shown in FIG. 1. FIG. 3 is a circuit diagram of a pixel according to an embodiment of the inventive concept. FIG. 4 is a sectional view of a pixel according to an embodiment of the inventive concept.

Referring to FIG. 1, an exemplary embodiment of a display device includes a display panel DP, a gate driving circuit 110, a data driving circuit 120, and a driving controller 130.

The display panel DP may use various display panel technologies such as a liquid crystal display, an organic light emitting display, an electrophoretic display, and an electrowetting display. In an exemplary embodiment, the display panel DP may be a liquid crystal display panel. A liquid crystal display device may further include a polarizer and a backlight unit.

The display panel DP includes a first substrate DS1, a second substrate DS2 spaced apart from the first substrate DS1, and a liquid crystal layer LCL disposed between the first substrate DS1 and the second substrate DS2. On a plane, the display panel DP includes a display area DA where a plurality of pixels PX11 to PXnm and a non display area NDA surrounding the display area DA. Where n and m are natural numbers greater than one.

The display panel DP includes a plurality of gate lines GL1 to GLn disposed on the first substrate DS1 and a plurality of data lines DL11 to DLm crossing the plurality of gate lines GL1 to GLn. The plurality of gate lines GL1 to GLn extend in a first direction X1 from the gate driving circuit 110 and the plurality of data lines DL1 to DLm extend in a second direction X2 from the data driving circuit 120. The data lines DL1 to DLm may be substantially perpendicular to the gate lines GL1 to GLn.

The plurality of gate lines GL1 to GLn are connected to the gate driving circuit 110. The plurality of data lines DL1 to DLm are connected to the data driving circuit 120. Only some of the plurality of gate lines GL1 to GLn and some of the plurality of data lines DL1 to DLm are illustrated in FIG. 1.

Only some of the plurality of pixels PX11 to PXnm are illustrated in FIG. 2. The plurality of pixels PX11 to PXnm are respectively connected to corresponding gate lines among the plurality of gate lines GL1 to GLn and corresponding data lines among the plurality of data lines DL1 to DLm. For example, odd pixels PX11 and PX13 among the plurality of pixels PX11 to PX1m are connected to an upper gate line, e.g. the first gate line GL1, and even pixels PX12 and PX14 are connected to a lower gate line, e.g. the second gate line GL2. Even pixels PX22 and PX24 among the plurality of pixels PX21 to PX2m are connected to an upper gate line, e.g. the first gate line GL3, and odd pixels PX21 and PX23 are connected to a lower gate line, e.g. the second gate line GL4. Each of the plurality of pixels PX11 to PX1m is connected to the left data line disposed adjacent to the plurality of pixels PX11 to PX1m. The plurality of pixels PX11 to PXnm may be divided into a plurality of groups according to a color. The plurality of pixels PX11 to PXnm may display one of the primary colors. The primary colors may include red, green, blue, or white. However, embodiments of the inventive concept are not limited thereto and thus the primary colors may further include yellow, cyan, magenta, and the like.

The gate driving circuit 110 and the data driving circuit 120 receive a control signal from the driving controller 130. The driving controller 130 may be mounted on a main circuit board MCB. The driving controller 130 receives image data and control signals from an external graphic control unit. The control signals may include vertical sync signals, horizontal sync signals, data enable signals (that indicate an on state during a section where data is outputted to the display), and clock signals.

The gate driving circuit 110 generates gate signals G1 to Gn on the basis of a control signal (hereinafter referred to as a gate control signal) received from the driving controller 130 through a signal line GSL and outputs the gate signals G1 to Gn to the plurality of gate lines GL1 to GLn. The gate signals G1 to Gn may be sequentially outputted to the corresponding horizontal sections HP. The gate driving circuit 110 and the pixels PX11 to PXnm may be formed simultaneously through a thin film process. For example, the gate driving circuit 110 may be mounted in an Oxide Semiconductor TFT Gate driver circuit (OSG) in the non display area NDA.

The data driving circuit 120 generates grayscale voltages according to image data provided from the driving controller 130 on the basis of a control signal (hereinafter referred to as a data control signal) received from the driving controller 130. The data driving circuit 120 outputs the grayscale voltages as data output signals D1 to Dm to the plurality of data lines DL1 to DLm.

The data output signals D1 to Dm may include positive data voltages having a positive value with respect to a common voltage and/or negative data voltages having a negative value with respect to the common voltage. Some of the data output signals D1 to Dm applied to the data lines DL1 to DLm may have a positive polarity and others may have a negative polarity. The polarity of the data output signals D1 to Dm may be inverted at each frame to prevent the deterioration of the liquid crystal. The data driving circuit 120 may generate data voltages, where the data voltages are inverted by each frame section unit in response to an invert signal.

The data driving circuit 120 may include a flexible circuit board 121 and a driving chip 122 mounted on the flexible circuit board 121. The data driving circuit 120 may include a plurality of driving chips 122 and a plurality of flexible circuit boards 121. The flexible circuit board 121 electrically connects a main circuit board MCB and a first substrate DS1. The plurality of driving chips 122 provide corresponding data signals to corresponding data lines among the plurality of data lines DL1 to DLm. The data driving circuit 120 includes a plurality of data output terminals DOUT1 to DOUTx (where x=½×m).

In the embodiment shown in FIG. 1, each data output terminal of the data driving circuit 120 is connected to two data lines. For example, the data output terminal DOUT1 is connected to the data lines DL1 and DL2 and the data output terminal DOUTx is connected to the data lines DLm−1 and DLm. A data driving circuit 120 that drives two data lines through one data output terminal may reduce the number of the data driving circuits 120 for a display device.

FIG. 1 illustrates an exemplary embodiment including a Tape Carrier Package (TCP) type data driving circuit 120. According to another embodiment of the inventive concept, the data driving circuit 120 may be disposed on the non display area NDA of the first substrate DS1 through a Chip on Glass (COG) method. Each of the plurality of pixels PX11 to PX1m shown in FIG. 1 may have an equivalent circuit shown in FIG. 3.

As shown in FIG. 3, a PXkj includes a pixel thin film transistor (hereinafter referred to as a pixel transistor) TR, a liquid crystal capacitor CLC, and a storage capacitor CST. Hereinafter, in the specification, a transistor refers to a thin film transistor. According to an exemplary embodiment of the inventive concept, the storage capacitor CST may be omitted.

The pixel transistor TR is electrically connected to a kth gate line GLk and a jth data line DLj. The pixel transistor TR outputs a pixel voltage corresponding to a data signal received from the jth data line DLj in response to a gate signal received from the kth gate line GLk.

The liquid crystal capacitor CLC is charged by a pixel voltage outputted from the pixel transistor TR. An arrangement of liquid crystal directors included in a liquid crystal layer LCL (see FIG. 4) is changed according to a charge amount charged in the liquid crystal capacitor CLC. The light incident to a liquid crystal layer may be transmitted or blocked according to an arrangement of liquid crystal directors.

The storage capacitor CST is connected in parallel to the liquid crystal capacitor CLC. The storage capacitor CST maintains an arrangement of liquid crystal directors during a predetermined section.

As shown in FIG. 4, the pixel transistor TR includes a control electrode GE connected to the kth gate line GLk (see FIG. 3), an activation part AL overlapping the control electrode GE, an input electrode SE connected to the jth data line DLj (see FIG. 3), and an output electrode DE is disposed apart from the input electrode SE.

The liquid crystal capacitor CLC includes a pixel electrode PE and a common electrode CE. The storage capacitor CST includes the pixel electrode PE and a part of the pixel electrode PE overlapping a storage line STL.

The kth gate line GLk and the storage line STL are disposed on one surface of the first substrate DS1. The control electrode GE is branched from the kth gate line GLk. The kth gate line GLk and the storage line STL may include a metal (such as Al, Ag, Cu, Mo, Cr, Ta, Ti, and so on) or an alloy thereof. The kth gate line GLk and the storage line STL may have a multi layer structure and may, for example, include a Ti layer and a Cu layer.

A first insulating layer 10 covering the control electrode GE and the storage line STL is disposed on one surface of the first substrate DS1. The first insulating layer 10 may include at least one of an inorganic material and an organic material. The first insulating layer 10 may be an organic layer or an inorganic layer. The first insulating layer 10 may have a multi layer structure and may, for example, include a silicon nitride layer and a silicon oxide layer.

The activation part AL overlapping the control electrode GE is disposed on the first insulating layer 10. The activation part AL is formed of an oxide semiconductor to form a channel of the thin film transistor TR. An oxide semiconductor used for forming the activation part AL may be formed of a material including an oxide (such as Zn, In, Ga, Sn, and the like) or a combination thereof (such as IGZO, ZnO, ZTO, ZIO, InO, TiO, and the like). According to another embodiment of the inventive concept, the activation part AL may be formed of amorphous silicon or polycrystalline silicon.

The output electrode DE and the input electrode SE are disposed on the activation part AL. The output electrode DE and the input electrode SE are disposed apart from each other. Each of the output electrode DE and the input electrode SE partially overlaps the control electrode GE.

A second insulating layer 20 covering the activation part AL, the output electrode DE, and the input electrode SE is disposed on the first insulating layer 10. The second insulating layer 20 may include at least one of an inorganic material and an organic material. The second insulating layer 20 may be an organic layer or an inorganic layer. The second insulating layer 20 may have a multi layer structure and may, for example, include a silicon nitride layer and a silicon oxide layer.

In an exemplary embodiment the pixel transistor TR has a staggered structure as illustrated in FIG. 1, but the structure of the pixel transistor TR is not limited thereto. In an exemplary embodiment the pixel transistor TR may have a planar structure.

A third insulating layer 30 is disposed on the second insulating layer 20. The third insulating layer 30 provides a flat surface. The third insulating layer 30 may include an organic material.

The pixel electrode PE is displayed on the third insulating layer 30. The pixel electrode PE is connected to the output electrode DE through a contact hole CH penetrating the second insulating layer 20 and the third insulating layer 30. An alignment layer covering the pixel electrode PE may be disposed on the third insulating layer 30.

A color filter layer CF is disposed on one surface of the second substrate DS2. The common electrode CE is disposed on the color filter layer CF. A common voltage is applied to the common electrode CE. A common voltage and a pixel voltage have different values. An alignment layer covering the common electrode CE may be disposed on the common electrode CE. Another insulating layer may be disposed between the color filter layer CF and the common electrode CE.

The pixel electrode PE and the common electrode CE with the liquid crystal layer LCL therebetween form the liquid crystal capacitor CLC. The pixel electrode PE and a part of the storage line STL, which are disposed with the first insulating layer 10, the second insulating layer 20, and the third insulating layer therebetween, form the storage capacitor CST. The storage line STL receives a storage voltage having a different value than a pixel voltage. A storage voltage may have the same value as a common voltage.

In an exemplary embodiment, at least one of the color filter layer CF and the common electrode CE may be disposed on the first substrate DS1. For example, a liquid display panel according to this embodiment of the inventive concept may include a pixel in a Vertical Alignment (VA) mode, a Patterned Vertical Alignment (PVA) mode, an in-plane switching (IPS) mode, a fringe-field switching (FFS) mode, or a Plane to Line Switching (PLS) mode.

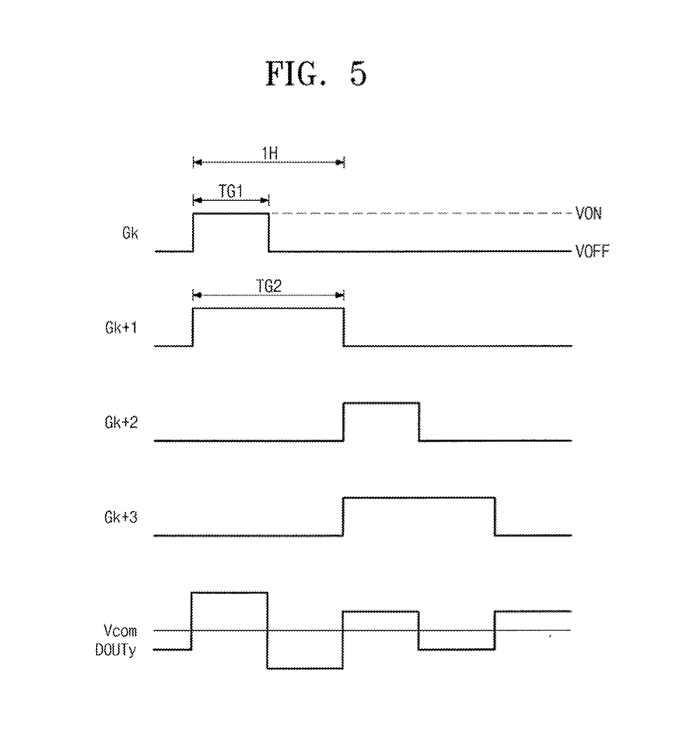

FIG. 5 is a timing diagram illustrating an operation of the display device shown in FIG. 1.

Referring to FIGS. 1 and 5, the gate driving circuit 110 drives the plurality of gate lines GL1 to GLn with a plurality of gate signals G1 to Gn switching between a gate on voltage VON and a gate off voltage VOFF. The gate driving circuit 110 sets the plurality of gate signals G1 to Gn to the gate on voltage VON sequentially. For example, the plurality of gate lines GL1 to GLn are driven sequentially by the gate on voltage VON.

According to an embodiment of the inventive concept shown in FIG. 5, the first gate signal GK provided to the first gate line GLk and the second gate signal Gk+1 provided to the second gate line GLk+1 adjacent to the first gate line GLk may transition to the gate on voltage VON simultaneously. In an embodiment of the invention the first gate signal Gk and the second gate signal Gk+1 may transition sequentially from the gate off voltage VOFF to the gate on voltage VON within a predetermined time.

A second gate section TG2 may be the pulse width of the second gate signal Gk+1 provided to the second gate line GLk+1. The second gate section TG2 may be less than or equal to one horizontal period 1H (TG2≦1H). A horizontal period is a period in which a data signal is provided to the pixels PX11 to PX1m in one row shown in FIG. 1. The second gate section TG2 is longer than a first gate section TG1 that is the pulse width of the first gate signal Gk provided to the first gate line GLk (TG2>TG1). The first gate section TG1 of the first gate signal Gk may be about 0.5×1H. Therefore, the first gate section TG1 of the first gate signal Gk provided to the first gate line GLk and the second gate section TG2 of the second gate signal Gk+1 provided to the second gate line GLk+1 partially overlap.

When the first gate signal Gk provided to the first gate line GLk outputs the gate on voltage VON, odd pixels PX11, PX13, . . . , PX1m−1 connected to the first gate line GLk receive data output signals D1, D3, . . . , Dm−1 provided through odd data lines DL1, DL3, DLm . . . , −1. When the second gate signal Gk+1 provided to the second gate line GLk+1 outputs the gate on voltage VON, even pixels PX12, PX14, . . . , PX1m connected to the second gate line GLk+1 receive data output signals D3, D4, . . . , Dm provided through even data lines DL2, DL4, . . . , DLm−1. The data driving circuit 120 alternately outputs the data output signal Dj to the jth data line DLj and the data output signal Dj+1 to the j+1th data line DLj+1 through a yth data output terminal DOUTy (where y is a positive integer of 1≦y≦x). For example, a data output signal is provided in the order of the pixels PX11, PX12, PX21, PX31, and so on through the data output terminal DOUT1 and a data output signal is provided in the order of the pixels PX13, PX14, PX22, PX23, and so on through the data output terminal DOUT2.

In an exemplary embodiment of the invention, the data driving circuit 120 may output a plurality of groups of data output signals D1 to Dm. For example, a first group of data output signals includes the odd numbered signals D1 to Dm−1 and a second group of data output signals including the even numbered signals D2 to Dm. The data driving circuit may output the first group of data output signals during a first half of a horizontal period (0.5×1H), associated with the first gate signal GK. The data driving circuit may output the second group of data output signals during a second half of a horizontal period (0.5×1H), associated with the second gate signal Gk+1.

If there is a switching circuit between the data output terminal DOUTy of the data driving circuit 120 and two data lines DLj and DLj+1, the data output signals Dj and Dj+1 may be affected by a kickback voltage from the switching circuit. Additionally, the charging rate of a pixel may be deteriorated by RC delay on a signal line for controlling a switching circuit. The kickback voltage and RC delay may be increased, as shown in FIG. 4, if the activation part AL is formed of an oxide semiconductor, the charging rate of a pixel may be further deteriorated.

In an exemplary embodiment such as the display device shown in FIG. 1, since one data output terminal DOUTy of the data driving circuit 120 is directly connected to two data lines DLj and DLj+1 the kickback voltage and RC delay may be eliminated. Without a switching circuit the data output signals Dj and Dj+1 outputted from a data output terminal may be delivered to data lines without loss.

Additionally, as shown in FIG. 5, since the second gate section TG2 of the second gate signal Gk+1 provided to the second gate line GLk+1 is long, the charging rate of pixels connected to the second gate line GLk+1 may be reduced and the wire width of the second gate line GLk+1 may be reduced.

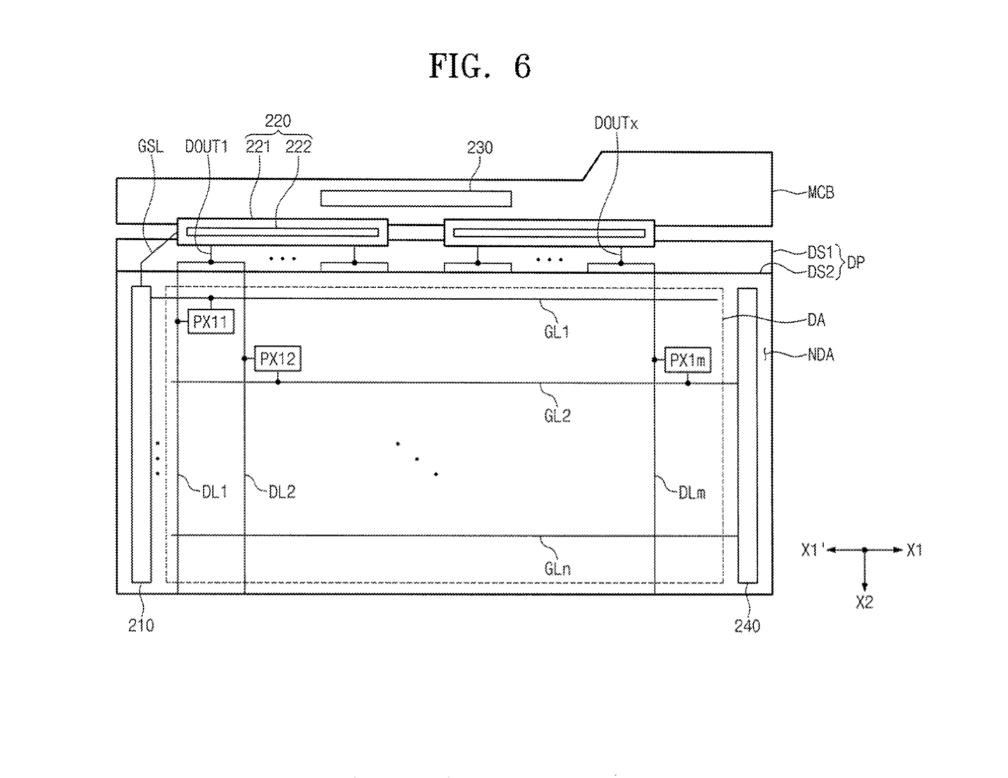

FIG. 6 is a plan view of a display device according to another embodiment of the inventive concept.

Referring to FIG. 6, a display device includes a display panel DP, a first gate driving circuit 210, a data driving circuit 220, a driving controller 230, and a second gate driving circuit 240. Unlike the display device shown in FIG. 1, the display device shown in FIG. 6 includes two gate driving circuits 210 and 240. Redundant description for the same configuration as that of the display device shown in FIG. 1 is omitted.

The display panel DP includes a plurality of gate lines GL1 to GLn disposed on the first substrate DS1 and a plurality of data lines DL11 to DLm crossing the plurality of gate lines GL1 to GLn. One group of gate lines GL1 to GLn−1 among the plurality of gate lines GL1 to GLn extend in a first direction X1 from the gate driving circuit 210 and the other group of the gate lines GL2 to GLn extend in a third direction X1′ from the data driving circuit 240. The plurality of data lines DL1 to DLm extend in a second direction X2 from the data driving circuit 220.

The one group of the odd numbered gate lines GL1 to GLn−1 are connected to the first gate driving circuit 210. The other group of even number gate lines GL2 to GLn are connected to the second gate driving circuit 240. The plurality of data lines DL1 to DLm are connected to one or more data driving circuits, for example the data driving circuit 220. The first gate driving circuit 210 may be connected to the left end of the one group of the odd numbered gate lines GL1 to GLn−1 and the. The second gate driving circuit 240 may be connected to the right end of the other group of the even numbered gate lines GL2 to GLn. The display panel DP shown in FIG. 6 includes the same pixel arrangement as the display panel DP shown in FIG. 2.

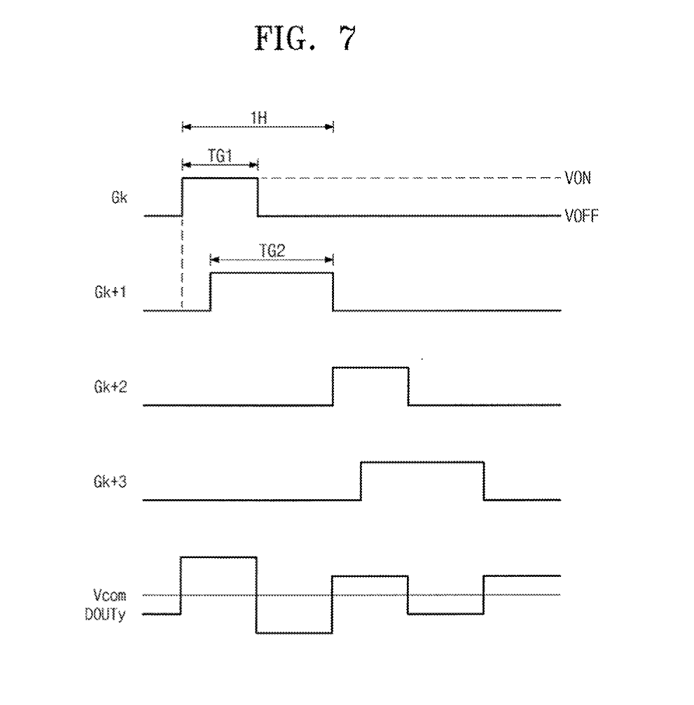

FIG. 7 is a timing diagram illustrating an operation of the display device shown in FIG. 6.

Referring to FIGS. 6 and 7, the first gate driving circuit 210 drives the plurality of odd numbered gate lines GL1 to GLn−1 with a plurality of gate signals G1 to Gn−1 switching between a gate on voltage VON and a gate off voltage VOFF. The second gate driving circuit 240 drives the plurality of even numbered gate lines GL2 to GLn with a plurality of gate signals G2 to Gn switching between a gate on voltage VON and a gate off voltage VOFF.

The first and second gate driving circuits 210 and 240 set the plurality of gate signals G1 to Gn to the gate on voltage VON sequentially. That is, the plurality of gate lines GL1 to GLn are sequentially driven to the gate on voltage VON.

According to an embodiment of the inventive concept shown in FIG. 7, the first gate signal GK provided to the first gate line GLk and the second gate signal Gk+1 provided to the second gate line GLk+1 adjacent to the first gate line GLk may transition to the gate on voltage VON within a predetermined time. The first gate signal Gk and the second gate signal Gk+1 may transition simultaneously from the gate off voltage VOFF to the gate on voltage VON. The first gate driving circuit 210 provides the first gate signal Gk to the first gate line GLk. The second gate driving circuit 240 provides the second gate signal Gk+1 to the second gate line GLk+1.

A second gate section TG2 that is the pulse width of the second gate signal Gk+1 provided to the second gate line GLk+1. The second gate section TG2 may be less than or equal to one horizontal period 1H (TG2≦1H). The second gate section TG2 is longer than a first gate section TG1 that is the pulse width of the first gate signal Gk provided to the first gate line GLk (TG2>TG1). The first gate section TG1 of the first gate signal Gk may be about 0.5×1H. Therefore, the first gate section TG1 of the first gate signal Gk provided to the first gate line GLk and the second gate section TG2 of the second gate signal Gk+1 provided to the second gate line GLk+1 partially overlap.

In an exemplary embodiment such as the display device in FIG. 6, since one data output terminal DOUTy of the data driving circuit 220 is directly connected to two data lines DLj and DLj+1, the data output signals Dj and Dj+1 outputted from a data output terminal may be delivered to data lines without loss.

Additionally, as shown in FIG. 7, since the second gate section TG2 of the second gate signal Gk+1 provided to the second gate line GLk+1 is long, the charging rate of pixels connected to the second gate line GLk+1 may be reduced and the wire width of the second gate line GLk+1 may be reduced.

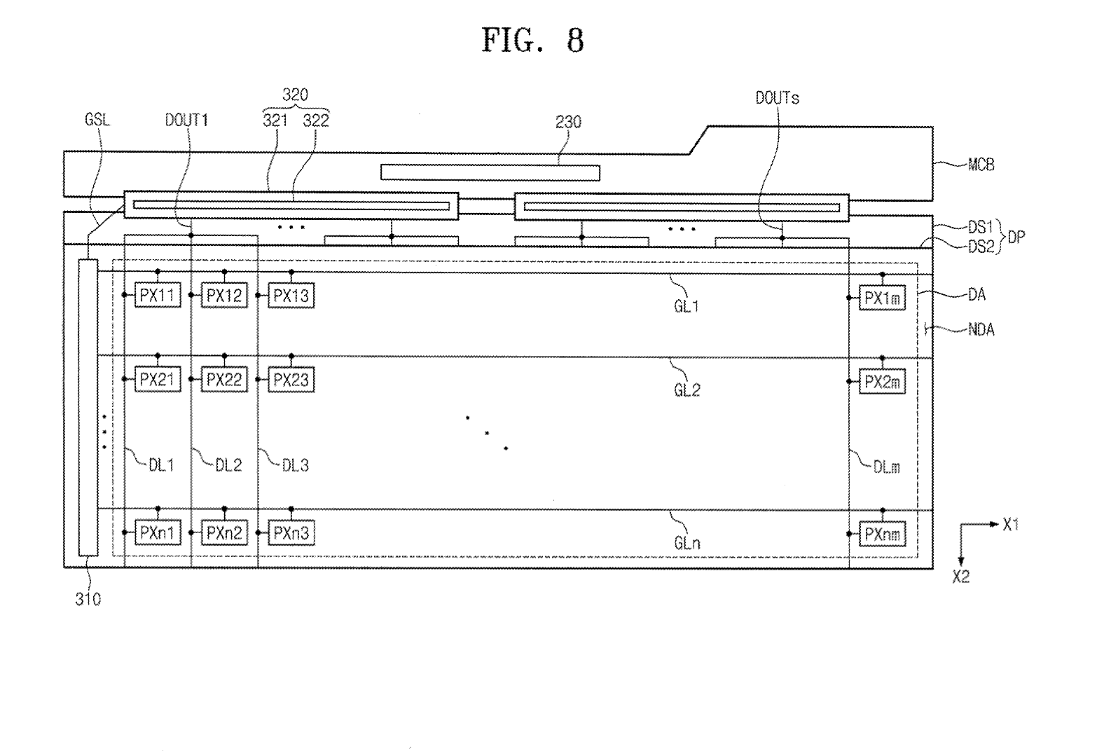

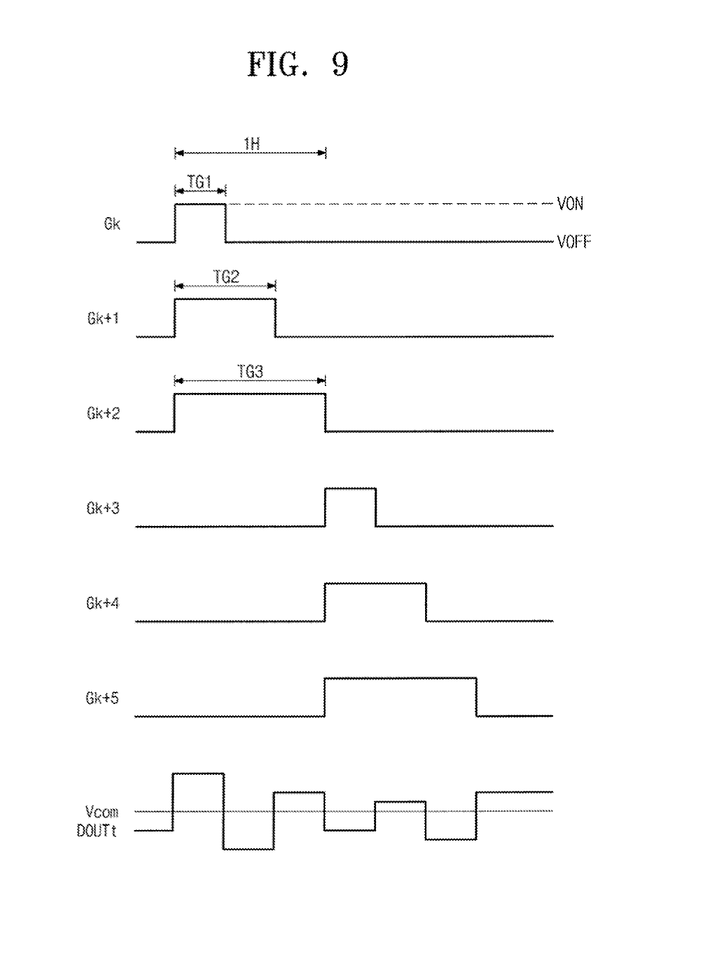

FIG. 8 is a plan view of a display device according to another embodiment of the inventive concept.

Referring to FIG. 8, a display device includes a display panel DP, a gate driving circuit 310, a data driving circuit 320, and a driving controller 330. Redundant description for the same configuration of the display device shown in FIG. 6 as that of the display device shown in FIG. 1 is omitted.

The display panel DP includes a plurality of gate lines GL1 to GLn disposed on the first substrate DS1 and a plurality of data lines DL11 to DLm crossing the plurality of gate lines GL1 to GLn. The plurality of gate lines GL1 to GLn extend in a first direction X1 from the gate driving circuit 310 and the plurality of data lines DL1 to DLm extend in a second direction X2 from the data driving circuit 320.

The data driving circuit 320 may include a flexible circuit board 321 and a driving chip 322 mounted on the flexible circuit board 321. The flexible circuit board 321 electrically connects a main circuit board MCB and a first substrate DS1. The plurality of driving chips 322 provide corresponding data signals to corresponding data lines among the plurality of data lines DL1 to DLm. The data driving circuit 320 includes a plurality of data output terminals DOUT1 to DOUTs (where s=⅓×m).

The plurality of gate lines GL1 to GLn are connected to the gate driving unit 310 and the plurality of data lines DL1 to DLm are connected to the data driving unit 320. The gate driving circuit 310 may be connected to the left end of the gate lines GL1 to GLn.

In the exemplary embodiment shown in FIG. 8, each data output terminal of the data driving circuit 320 is connected to three data lines. For example, the data output terminal DOUT1 is connected to the data lines DL1, DL2, and DL3 and the data output terminal DOUTs is connected to the data lines DLm−2, DLm−1, and DLm. Since the data driving circuit 320 drives three data lines through one data output terminal, the number of the data driving circuits 320 for a display device may be reduced.

FIG. 9 is a timing diagram illustrating an operation of the display device shown in FIG. 8.

Referring to FIGS. 8 and 9, the gate driving circuit 310 drives the plurality of gate lines GL1 to GLn with a plurality of gate signals G1 to Gn switching between a gate on voltage VON and a gate off voltage VOFF.

The gate driving circuits 310 sequentially sets the plurality of gate signals G1 to Gn to the gate on voltage VON. For example, the plurality of gate lines GL1 to GLn are driven sequentially by the gate on voltage VON.

According to an embodiment of the inventive concept shown in FIG. 9, the first gate signal GK provided to the first gate line GLk, the second gate signal Gk+1 provided to the second gate line GLk+1 adjacent to the first gate line GLk, and the third gate signal Gk+2 provided to the third gate line GLk+2 adjacent to the second gate line GLk+1 may simultaneously transition to the gate on voltage VON but the first to third gate signals Gk to Gk+2 may sequentially transition from the gate off voltage VOFF to the gate on voltage VON within a predetermined time.

A second gate section TG2, that is the pulse width of the second gate signal Gk+1, is longer than a first gate section TG1, that is the pulse width of the first gate signal Gk, (TG2>TG1). Additionally, a third gate section TG3, that is the pulse width of the third gate signal Gk+2, is longer than the second gate section TG2, that is the pulse width of the second gate signal Gk+1, (TG3>TG2).

The first gate section TG1 of the first gate signal Gk may be 0.5×1H. Additionally, the second gate section TG2 is less than one horizontal period 1H (TG2<1H) and the third gate section TG3 is less than or equal to the one horizontal period 1H (TG3≦1H). For example, the second gate section TG2 is a ×(1H) where ⅓<a≦⅔ and the third gate section TG3 is b×(1H) where ⅔<b≦(1H).

The first gate section TG1 of the first gate signal Gk provided to the first gate line GLk and the second gate section TG2 of the second gate signal Gk+1 provided to the second gate line GLk+1 partially overlap. Additionally, the second gate section TG2 of the second gate signal Gk+1 provided to the second gate line GLk+1 and the third gate section TG3 of the third gate signal Gk+2 provided to the third gate line GLk+2 overlap partially.

As shown in FIG. 9, in the display device, since one data output terminal DOUTt of the data driving circuit 320 is directly connected to three data lines DLj, DLj+1, and DLj+2, the data output signals Dj, Dj+1, and Dj+2 outputted from a data output terminal may be respectively delivered to data lines without loss.

Additionally, as shown in FIG. 9, since the second gate section TG2 of the second gate signal Gk+1 and the third gate section TG3 of the third gate signal Gk+2 are sufficiently long, the charging rate of the pixels connected to the second gate line GLk+1 and the third gate line GLk+2 may be reduced and the wire widths of the second gate line GLk+1 and the third gate line GLk+2 may be reduced.

One data output terminal of a data driver IC provided in a display device having such a configuration is commonly connected to two or more data lines. Therefore, the number of data driver ICs for a display device may be reduced. Especially, since data lines are directly connected to the output terminal of a data driver IC, a loss on a data line is minimized, so that the charging rate of a pixel may be improved.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A display device comprising:
a display panel comprising a plurality of pixels respectively connected to a plurality of gate lines and a plurality of data lines;
a gate driving circuit configured to drive the plurality of gate lines;
a data driving circuit configured to output a first data output signal to a first group of pixels and a second data output signal to a second group of pixels sequentially during one horizontal period;
a data output terminal connected to the data driving circuit at a first end and connected to a first data line and a second data line at a second end;
the first data line connected to the first group of pixels;
the second data line connected to the second group of pixels; and
a driving controller configured to control the gate driving circuit and to provide a data signal to the data driving circuit.

2. The display device of claim 1, wherein
the gate driving circuit drives the plurality of gate lines sequentially to a gate on voltage; and
a first gate section where a first gate line is driven to the gate on voltage and a second gate section where a second gate line adjacent to the first gate line is driven to the gate on voltage at about a same time as the first gate line.

3. The display device of claim 2, wherein the second gate section where the second gate line is driven to the gate on voltage longer than the first gate section.

4. The display device of claim 2, wherein the first gate section where the first gate line is driven to the gate on voltage for one half of one horizontal period.

5. The display device of claim 4, wherein the second gate section where the second gate line is driven to the gate on voltage for more than one half of one horizontal period.

6. The display device of claim 1, wherein a first data section where the data driving circuit outputs a first data output signal to a pixel of the first group of pixels connected to the first data line during a first half of one horizontal period.

7. The display device of claim 1, wherein a second data section where the data driving circuit outputs a second data output signal to a pixel of the second group of pixels connected to the second data line during the second half of one horizontal period.

8. The display device of claim 1, wherein the gate driving circuit is disposed at one side of the display panel.

9. The display device of claim 2, wherein the gate driving circuit comprises:
a first gate driving circuit disposed at a first side surface of the display panel and configured to drive the first gate line; and
a second gate driving circuit disposed at a second side surface of the display panel and configured to drive the second gate line.

10. The display device of claim 1, wherein
the display panel further comprises a third group of pixels connected to a third data line; and
the data output terminal of the data driving circuit is connected to the first, second, and third data lines at the second end.

11. The display device of claim 10, wherein
the gate driving circuit drives the plurality of gate lines sequentially to a gate on voltage;
a first gate section where a first gate line is driven to the gate on voltage and a second gate section where a second gate line adjacent to the first gate line is driven to the gate on voltage at about a same time as the first gate line; and
a second gate section where the second gate line is driven to the gate on voltage and a third gate section where a third gate line adjacent to the second gate line is driven to the gate on voltage at about a same time as the second gate line.

12. The display device of claim 10, wherein a first data section where the data driving circuit outputs a first data output signal to a pixel of a first group of pixels connected to the first data line during a first interval, wherein an interval is one third of one horizontal period.

13. The display device of claim 12, wherein a second data section where the data driving circuit outputs a second data output signal to a pixel of a second group of pixels connected to the second data line during a second interval.

14. The display device of claim 13, wherein a third data section where the data driving circuit outputs a third data output signal to a pixel of a third group of pixels connected to the third data line during a third interval.

15. A display device comprising:
a display panel;
a driving controller configured to provide a data output signal to one or more data driving circuits and control one or more gate driving circuits;
a gate driver circuit configured to drive a plurality of gate lines;
the one or more data driving circuits configured to output the data output signal to a data output terminal; and
the data output terminal configured to output the data output signal to a plurality of data lines, wherein each data line is connected to a plurality of pixels.

16. The display device of claim 15, further comprising:
a first data line and a second data line connected to the data output terminal;
the first data line connected to a first group of pixels;
the second data line connected to a second group of pixels; and
the gate driver circuit connected to a first group of gate lines and a second group of gate lines; and
the first group of pixels are driven by the first group of gate lines and the second group of pixels are driven by the second group of gate lines.

17. The display device of claim 16, wherein:
the gate driver circuit is configured to output a first gate signal to the first group of gate lines and a second gate signal to the second group of gate lines, the first gate signal reaches a gate on voltage for a first half of one horizontal period. the second gate signal reaches a gate on voltage for one horizontal period, and the first gate signal and the second gate signal may reach the gate on voltage at about the same time.

18. The display device of claim 15, wherein the gate driving circuit comprises:
a first gate driving circuit disposed at a first side surface of the display panel and configured to drive the first group of gate lines; and
a second gate driving circuit disposed at a second side surface of the display panel and configured to drive the second group of gate line.
